(19) United States
(12) Patent Application Publication
(10) Pub. No.: US 2026/0070270 A1
(43) Pub. Date: Mar. 12, 2026

(54) COMPOSITION, MOLDED BODY, AND METHOD FOR PRODUCING COMPOSITION

(71) Applicants: FUJIFILM Corporation, Tokyo (JP); FUJIFILM Business Innovation Corp., Tokyo (JP)

(72) Inventors: Ryuta TAKEGAMI, Shizuoka (JP); Naoki TSUKAMOTO, Shizuoka (JP); Kenji YAO, Kanagawa (JP)

(73) Assignees: FUJIFILM Corporation, Tokyo (JP); FUJIFILM Business Innovation Corp., Tokyo (JP)

(21) Appl. No.: 19/390,672

(22) Filed: Nov. 17, 2025

Related U.S. Application Data
(63) Continuation of application No. PCT/JP2024/018279, filed on May 17, 2024.

(30) Foreign Application Priority Data
Jun. 15, 2023 (JP) 2023-098244

(51) Int. Cl. B29C 45/00; B29K 1/00; B29K 67/00; B29K 71/00; C08J 3/00; C08K 5/05; C08K 5/10; C08K 5/13

(52) U.S. Cl. CPC B29C 45/0001; C08J 3/005; C08K 5/05; C08K 5/10; C08K 5/13; B29K 2001/12; B29K 2003/00; B29K 2067/00; B29K 2071/02; B29K 2995/0089; C08J 2301/12; C08J 2403/02; C08J 2467/00; C08J 2471/02

(57) ABSTRACT

An object of the present invention is to provide a composition having excellent surface impact strength and a method for producing a composition. The composition according to the embodiment of the present invention is a composition containing a cellulose derivative and a polyrotaxane, and is amorphous.

### CROSS-REFERENCE TO RELATED APPLICATIONS

This application is a Continuation of PCT International Application No. PCT/JP2024/018279 filed on May 17, 2024, which claims priority under 35 U.S.C. § 119(a) to Japanese Patent Application No. 2023-98244 filed on Jun. 15, 2023. The above applications are hereby expressly incorporated by reference, in their entirety, into the present application.

### BACKGROUND OF THE INVENTION

### 1. Field of the Invention

The present invention relates to a composition, a molded body, and a method for producing a composition.

### 2. Description of the Related Art

In the related art, various types of resin compositions have been developed and used as various parts and housings of various products such as home appliances, automobiles, office equipment, and electronic and electric equipment. In particular, in a case of use for applications such as aerospace, automobiles, and sporting goods, high strength comparable to that of metals is required, and various high-strength resin materials such as engineering plastics and super engineering plastics have been developed.

In addition, in recent years, from an environmental point of view, there has also been an increasing demand to use a biomass-derived resin and a resin composition exhibiting biodegradability in the above-described applications.

As the above-described resin composition, for example, JP2020-037614A discloses a resin composition containing a resin having a biomass-derived carbon atom and satisfying a specific requirement.

### SUMMARY OF THE INVENTION

As a result of an examination of the resin composition described in JP2020-037614A, the present inventors have found that there is room for further improvement in surface impact strength.

It is noted that in the present specification, the expression that the surface impact strength is excellent means that the maximum impact force and the energy at the maximum impact force are excellent.

Therefore, an object of the present invention is to provide a composition having excellent surface impact strength.

In addition, another object of the present invention is to provide a molded body of the composition and a method for producing a composition.

As a result of conducting an extensive investigation to achieve the objects, the present inventors have found that the objects can be achieved by the following constitution.
[1]A composition comprising a cellulose derivative and a polyrotaxane, in which the composition is amorphous.
[2] The composition according to [1], in which the cellulose derivative is a cellulose acylate.
[3] The composition according to [2], in which an acyl substitution degree of the cellulose acylate is 1.7 to 2.6.
[4] The composition according to any one of [1] to [3], in which the cellulose derivative is at least one selected from the group consisting of a cellulose acetate, a cellulose acetate propionate, and a cellulose acetate butyrate.
[5] The composition according to any one of [1] to [4], in which the cellulose derivative is a cellulose acetate.
[6] The composition according to [5], in which an acetyl substitution degree of the cellulose acetate is 1.7 to 2.6.
[7] The composition according to any one of [1] to [6], further comprising a plasticizer.
[8] The composition according to [7], in which the plasticizer is at least one selected from the group consisting of a cardanol compound, a carboxylic acid ester compound, and an alkyl diol having 9 to 14 carbon atoms.
[9] The composition according to any one of [1] to [8], in which a mass ratio of a content of the polyrotaxane to a content of the cellulose derivative is 0.10 or less.
[10]A molded body consisting of the composition according to any one of [1] to [9].
[11] The molded body according to [10], in which a maximum impact force is 4,000 N or more.
[12]A method for producing a composition which contains a cellulose derivative and a polyrotaxane and is amorphous, the method comprising a step of melt-kneading the cellulose derivative and the polyrotaxane in a substantially solvent-free manner.

According to the present invention, it is possible to provide a composition having excellent surface impact strength.

In addition, according to the present invention, it is also possible to provide a molded body of the composition and a method for producing a composition.

### DESCRIPTION OF THE PREFERRED EMBODIMENTS

Hereinafter, the present invention will be described in more detail.

The description of the configuration requirements described below may be made based on the representative embodiments of the present invention, but the present invention is not limited to those embodiments.

In the present specification, numerical ranges represented by “to” include numerical values before and after “to” as lower limit values and upper limit values.

In addition, in the present specification, in a case where there are two or more components corresponding to a certain component, “content” of such a component means the total content of the two or more components.

In the numerical range described stepwise in the present specification, the upper limit value or the lower limit value described in a certain numerical range may be replaced with the upper limit value or the lower limit value of another numerical range described stepwise. In addition, in a numerical range described in the present specification, an upper limit or a lower limit described in a certain numerical range may be replaced with a value described in Examples.

In the present specification, a combination of two or more preferred embodiments is a more preferred embodiment.

In the present specification, in a case where there are a plurality of substituents, linking groups, and the like (hereinafter, referred to as substituents and the like) represented by specific reference numerals, or a case where a plurality of substituents and the like are simultaneously specified, it means that the respective substituents and the like may be the same as or different from each other. The same applies to the definition of the number of substituents or the like.

### [Composition]

Hereinafter, the composition according to the embodiment of the present invention will be described in detail.

The composition according to the embodiment of the present invention (hereinafter, also simply referred to as a “composition”) contains a cellulose derivative and a polyrotaxane, and is amorphous.

Although the reason why the composition having the above-mentioned configuration can achieve the objects of the present invention is not always clear, the present inventors speculate as follows.

The mechanism by which the effect is obtained is not limited by the following speculation. In other words, even in a case where an effect is obtained by a mechanism other than the following, it is included in the scope of the present invention.

Since the amorphous composition containing a cellulose derivative does not have a crystal structure, the mechanical strength is reduced. On the other hand, the composition according to the embodiment of the present invention, by further containing a polyrotaxane, can relieve impact energy due to the ring-rotation structure of the polyrotaxane, thereby overturning conventional wisdom, and is considered to exhibit extremely excellent surface impact strength as compared with crystalline compositions.

### [Cellulose Derivative]

The composition contains a cellulose derivative.

The cellulose derivative refers to a modified cellulose in which at least a part of hydroxy groups contained in cellulose, which is a natural polymer, is chemically modified. The above-described chemical modification is not particularly limited, and examples thereof include esterification, alkyl etherification, and hydroxyalkyl etherification of a hydroxy group, and esterification thereof is preferable. In other words, suitable examples of the cellulose derivative include a cellulose acylate, an alkyl cellulose, and a hydroxyalkyl cellulose, and the cellulose acylate is more preferable.

In a case where the resin constituting the composition is a cellulose derivative, the composition can exhibit biodegradability. In other words, the composition according to the embodiment of the present invention has excellent surface impact strength while exhibiting biodegradability.

### <Cellulose Acylate>

The cellulose acylate is a cellulose derivative in which a hydrogen atom in at least a part of hydroxy groups contained in cellulose is substituted with an acyl group.

Examples of the cellulose acylate include cellulose derivatives represented by General Formula (CA).

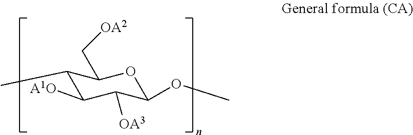

In General Formula (CA), A¹, A², and A³ each independently represent a hydrogen atom or an acyl group. n represents an integer of 2 or more. Provided that at least one or more of n pieces of A¹, n pieces of A², and n pieces of A³ represent an acyl group.

A¹, A², and A³, each of which is present n pieces in the molecule, may be the same as or different from each other.

The hydrocarbon group of the acyl groups represented by A¹, A², and A³ may be any of an aliphatic hydrocarbon group or an aromatic hydrocarbon group, but is preferably an aliphatic hydrocarbon group.

The above-described aliphatic hydrocarbon group may be linear, branched, or cyclic, and is preferably linear or branched, and more preferably linear.

The aliphatic hydrocarbon group may be any of a saturated aliphatic hydrocarbon group or an unsaturated aliphatic hydrocarbon group, but is preferably a saturated aliphatic hydrocarbon group.

From the viewpoint that the effect of the present invention is more excellent, the number of carbon atoms in the above-described acyl group is preferably 1 to 6, more preferably 2 to 4, and still more preferably 2 or 3.

The acyl group may have a substituent, but is also preferably unsubstituted. Examples of the substituent include a halogen atom (for example, a fluorine atom, a chlorine atom, a bromine atom, and an iodine atom), a hydroxy group, an amino group, and the like.

Examples of the acyl group include a formyl group, an acetyl group, a propionyl group, a butyryl group (butanoyl group), a propenoyl group, a hexanoyl group, and the like, and an acetyl group, a propionyl group, or a butyryl group is preferable and an acetyl group is more preferable.

Examples of the cellulose acylate include a cellulose acetate (cellulose monoacetate, cellulose diacetate (DAC), cellulose triacetate, and the like), a cellulose acetate propionate (CAP), and a cellulose acetate butyrate (CAB), and a cellulose acetate is preferable from the viewpoint that the effect of the present invention is more excellent.

The weight-average molecular weight (Mw) of the cellulose acylate is preferably 20,000 to 200,000, more preferably 70,000 to 180,000, and still more preferably 90,000 to 160,000.

From the viewpoint that the effects of the present invention and the moldability are more excellent, the weight-average degree of polymerization of the cellulose acylate is preferably 150 to 1,000 and more preferably 300 to 700.

As the weight-average molecular weight (Mw) of the cellulose acylate, a polystyrene-equivalent value measured using a gel permeation chromatography apparatus (GPC apparatus: manufactured by Tosoh Corporation, HLC-8320GPC, column: TSKgel α-M) with tetrahydrofuran as a solvent can be used.

The weight-average degree of polymerization can be calculated by dividing the obtained weight-average molecular weight (Mw) by the molecular weight of the constitutional unit of cellulose acylate. The molecular weight of the constitutional unit of the cellulose acylate is, for example, 263 in a case where the acetyl substitution degree is 2.4.

From the viewpoint that the effect of the present invention is more excellent, the acyl substitution degree of the cellulose acylate is preferably 1.4 to 2.9, more preferably 1.7 to 2.6, and still more preferably 2.3 to 2.5.

The acyl substitution degree is an index representing the degree to which hydrogen atoms of the hydroxy group contained in cellulose are substituted with acyl groups (that is, acylated), and specifically means the average in the molecule of the acylated hydroxy group among three hydroxy groups present in the D-glucopyranose unit. The acyl substitution degree is determined from the integral ratio between the peak of the hydrogen atom derived from cellulose and the peak of the hydrogen atom derived from the acyl group, which are obtained from ¹H-NMR.

Specifically, the acyl substitution degree is obtained by performing ¹H-NMR (JMN-ECA, manufactured by JEOL Resonance Inc.) measurement using tetramethylsilane as a reference substance, and according to the following expression (10) in which the integral value of a peak derived from a hydroxy group present at a chemical shift of 4.5 to 5.5 ppm is defined as P1 and a value obtained by dividing the integral value of a peak derived from an acyl group present at a chemical shift of 2.5 to 3.5 ppm by the number of hydrogens of the corresponding acyl group (for example, in a case of an acetyl group, the number of hydrogens is 3) is defined as P2. As the solvent in the ¹H-NMR measurement, a solvent selected from tetrahydrofuran-d8, chloroform-d, methanol-d4, and dimethyl sulfoxide-d6 can be used, and tetrahydrofuran-d8 is preferably used.

$$Acyl substitution degree = P 2 / ( P 1 + P 2 ) \qquad Formula ( 10 )$$

In the cellulose acetate propionate (CAP), a ratio of a degree of substitution of acetyl groups to a degree of substitution of propionyl groups is preferably 0.01 to 1.0 and more preferably 0.05 to 0.1.

In the cellulose acetate butyrate (CAB), a ratio of the degree of substitution of acetyl groups to the degree of substitution of butyryl groups is preferably 0.05 to 3.5 and more preferably 0.5 to 3.0.

In cellulose acetates, the acetyl substitution degree is preferably 1.4 to 2.9, more preferably 1.7 to 2.6, and still more preferably 2.3 to 2.5.

The acetyl substitution degree is determined by the same method as the above-described acyl substitution degree.

Examples of the cellulose derivative other than cellulose acetate include alkyl celluloses such as methyl cellulose, ethyl cellulose, propyl cellulose, and butyl cellulose, hydroxyalkyl celluloses such as hydroxyethyl cellulose, hydroxypropyl cellulose, hydroxypropyl methylcellulose, and hydroxybutyl methylcellulose, carboxymethyl cellulose, and nitrocellulose.

The cellulose derivative may be used alone or in combination of two or more types thereof.

From the viewpoint that the effect of the present invention is more excellent, the content of the cellulose derivative is preferably 70% by mass or more and more preferably 80% by mass or more with respect to the total mass of the composition. The upper limit of the content of the cellulose derivative is less than 100% by mass, preferably 99% by mass or less, and more preferably 93% by mass or less, with respect to the total mass of the composition.

### [Polyrotaxane]

The composition contains a polyrotaxane.

The polyrotaxane is a molecular complex in which the openings of a plurality of cyclic molecules are pierced in a skewer-like manner by an axle molecule, a plurality of the cyclic molecules encircle the axle molecule to form a pseudo-polyrotaxane, and blocking groups are disposed at both termini of the pseudo-polyrotaxane (both termini of the axle molecule) such that the cyclic molecules do not dissociate.

In the polyrotaxane, the cyclic molecules can freely move on the axle molecule, thereby exhibiting an effect of relieving external stress and internal stress. It is considered that since the composition contains a polyrotaxane in addition to the above-described cellulose derivative, stress is relieved in a case where a surface impact is applied, thereby exhibiting an excellent surface impact strength.

### <Axle Molecule>

The axle molecule in the polyrotaxane has an axial portion that penetrates the cyclic molecules, and further has a blocking group at the terminus of the axial portion to prevent the cyclic molecules from dissociating.

The axial portion of the axle molecule is not particularly limited, but is preferably a divalent aliphatic hydrocarbon group and more preferably an alkylene group.

One or two or more carbon atoms constituting the divalent aliphatic hydrocarbon group may be substituted with —O—, —S—, —SO₂—, —N(R)— (R: hydrogen atom or substituent), —CO—, —COO—, —CONR— (R: hydrogen atom or substituent), or a group obtained by combining these.

From the viewpoint that the effect of the present invention is more excellent, it is preferable that in the divalent aliphatic hydrocarbon group, at least one carbon atom constituting the divalent aliphatic hydrocarbon group is substituted with —O—, —S—, —SO₂—, —N(R)— (R: hydrogen atom or substituent), —CO—, —COO—, —CONR— (R: hydrogen atom or substituent), or a group obtained by combining these groups.

The axle molecule is preferably formed by introducing a blocking group into a molecule constituting an axial portion having a functional group (for example, a hydroxy group, an amino group, a carboxy group, a thiol group, and the like) into which a blocking group can be introduced.

The molecules constituting the above-described axial portion are preferably linear molecules, and examples thereof include polyalkylene glycols such as polyethylene glycol, polypropylene glycol, and polytetramethylene glycol; polyesters such as polycaprolactone diol, polylactic acid, polyethylene adipate, polybutylene adipate, polyethylene terephthalate, and polybutylene terephthalate; hydroxyl-terminated polyolefins such as polybutadiene diol, polyisoprene diol, polyisobutylene diol, poly(acrylonitrile-butadiene) diol, hydrogenated polybutadiene diol, polyethylene diol, and polypropylene diol; terminally functionalized polysiloxanes such as silanol-terminated polydimethylsiloxane; and amino-terminated chain polymers such as amino-terminated polyethylene glycol, amino-terminated polypropylene glycol, and amino-terminated polybutadiene.

As the molecule constituting the axial portion, polyalkylene glycols or polyesters are preferable.

The blocking group may be any group as long as it is a group having a function of holding the cyclic molecule not to dissociate from the axle molecule, and examples thereof include a bulky substituent.

Examples of the blocking group include a dinitrophenyl group, a cyclodextrin group, an adamantyl group, a trityl group, a fluoresceinyl group, a pyrenyl group, an anthracenyl group, derivatives thereof, and the like.

The weight-average molecular weight (Mw) of the axle molecule is preferably 5,000 to 50,000 and more preferably 10,000 to 30,000.

### <Cyclic Molecule>

The cyclic molecule is not particularly limited as long as it is a cyclic molecule capable of encircling the above-described axle molecule, and examples thereof include cyclodextrins (for example, α-cyclodextrin, β-cyclodextrin, γ-cyclodextrin, dimethylcyclodextrin, and glucosylcyclodextrin), crown ethers, benzo-crown ethers, dibenzo-crown ethers, dicyclohexano-crown ethers, calixarenes, macrocyclic amines, cyclophanes, and derivatives or modified products thereof. From the viewpoint of excellent compatibility with the cellulose derivative, cyclodextrins are preferable and α-cyclodextrin, β-cyclodextrin, γ-cyclodextrin, or a derivative thereof is more preferable.

The cyclic molecule may have a functional group or may be modified with a hydrophobic group. Examples of the functional group include a polymerizable group (for example, an ethylenically unsaturated double bond), an amino group, a glycidyl group, a carboxy group, an isocyanate group, a thiol group, a sulfonic acid group, and the like.

The cyclic molecule may have a side chain. The expression “the cyclic molecule has a side chain” is intended to refer to an aspect in which the cyclic molecule is modified with a polymer chain, and examples thereof include an aspect in which a hydroxy group of cyclodextrins is modified with a polymer chain.

The side chain is not particularly limited, and examples thereof include polyester. Examples of the polyester include polycaprolactone, poly(lactic acid), poly(glycolic acid), poly(3-hydroxybutyrate), and poly(4-hydroxybutyrate), and polycaprolactone is preferable.

It is also preferable that the above-described cyclodextrins do not have a side chain. It is presumed that, by using cyclodextrins having no side chain as a cyclic molecule, the compatibility between the cellulose derivative and the polyrotaxane is excellent, the polyrotaxane is uniformly dispersed, and the effect of improving the surface impact strength derived from the polyrotaxane works more efficiently, whereby the effect of the present invention is more excellent.

The weight-average molecular weight (Mw) of the polyrotaxane is preferably 10,000 to 1,000,000, more preferably 10,000 to 900,000, and still more preferably 15,000 to 900,000.

The weight-average molecular weight (Mw) of the polyrotaxane can be measured by gel permeation chromatography (GPC) or the like.

The polyrotaxane can be synthesized by a known method. For example, the polyrotaxane can be synthesized by a method of mixing a molecule constituting the axial portion with a cyclic molecule to form a pseudo-polyrotaxane and then introducing a blocking group.

From the viewpoint that the effect of the present invention is more excellent, the mass ratio of the content of the polyrotaxane to the content of the cellulose derivative is preferably 0.50 or less, more preferably 0.10 or less, and still more preferably 0.05 or less. The mass ratio of the content of the polyrotaxane to the content of the cellulose derivative is more than 0, and is preferably 0.001 or more and more preferably 0.002 or more from the viewpoint that the effect of the present invention is more excellent.

In addition, the mass ratio of the content of the polyrotaxane to the content of the cellulose derivative is also preferably 0.001 to 0.50, more preferably 0.001 to 0.10, and still more preferably 0.002 to 0.05.

Even in a case where the content of the polyrotaxane is as small as a mass ratio of 0.10 or less with respect to the content of the cellulose derivative, the composition according to the embodiment of the present invention exhibits a significantly improved surface impact strength at a level that has not been assumed in the related art as compared with a composition not containing the polyrotaxane, and exhibits a surface impact strength comparable to that of a so-called super engineering plastic.

The content of the polyrotaxane is preferably 0.01% to 20% by mass, more preferably 0.1% to 10% by mass, and still more preferably 0.2% to 5% by mass, with respect to the total mass of the composition.

It is noted that the content of each component (for example, the polyrotaxane) can be calculated from the mass of each component extracted by liquid separation or the like and the mass of the composition and other components before extraction.

Specifically, for example, the content of the polyrotaxane can be calculated by the following method. A composition containing a cellulose derivative (for example, cellulose acetate) and a polyrotaxane soluble in water (for example, a polyrotaxane composed of an axle molecule derived from polyethylene oxide and a cyclodextrin as a cyclic molecule) is dissolved in methylene chloride, water is then added thereto to perform a liquid separation operation, and the cellulose derivative (for example, cellulose acetate) is extracted into the methylene chloride phase and the polyrotaxane is extracted into the water phase. After the liquid separation, the content of the polyrotaxane with respect to the total mass of the composition is quantified from the mass of the solid content obtained by drying each phase.

### [Plasticizer]

From the viewpoint that the effect of the present invention and the moldability are more excellent, it is preferable that the composition further contains a plasticizer. By containing the plasticizer, the flexibility of the composition is improved, and the surface impact strength is more excellent.

Examples of the plasticizer include a cardanol compound, an ester compound, an alkyl diol, a polyol, camphor, a metal soap, and a polyalkylene oxide, and a cardanol compound, an ester compound, or an alkyl diol is preferable and a cardanol compound is more preferable.

### <Cardanol Compound>

The cardanol compound is a component contained in a natural-derived compound using cashew as a raw material and a derivative thereof, and examples of the natural-derived compound using cashew as a raw material include compounds represented by Formulae (c-1) to (c-4).

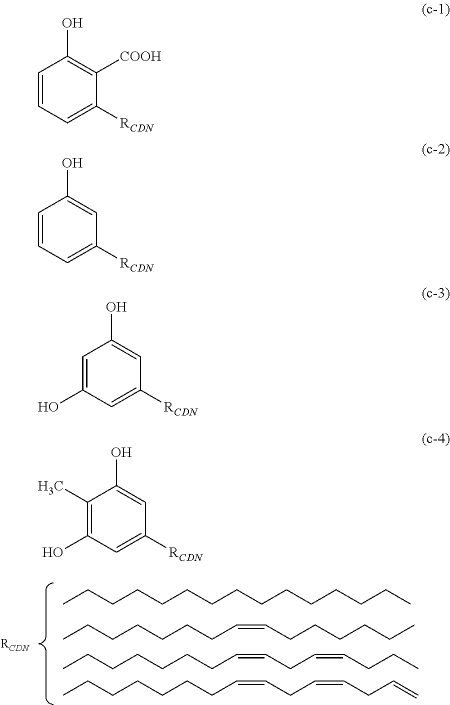

The cardanol compound may be used alone or in combination of two or more types thereof. That is, the cardanol compound may be a mixture of natural-derived compounds using cashew as a raw material (hereinafter, also referred to as a “cashew-derived mixture”).

The cardanol compound may be a derivative of the cashew-derived mixture, and examples thereof include the following compounds and mixtures.
Mixture in which the compositional ratio of each component in the cashew-derived mixture is adjusted
A single substance obtained by isolating only a specific component from the cashew-derived mixture
Mixture containing modified product obtained by modifying components in the cashew-derived mixture
Mixture containing polymer obtained by polymerizing components in the cashew-derived mixture
Mixture containing modified polymer obtained by modifying and polymerizing components in the cashew-derived mixture
Mixture containing modified product obtained by further modifying components in mixture in which compositional ratio is adjusted
Mixture containing polymer obtained by further polymerizing components in mixture in which compositional ratio is adjusted
Mixture containing modified polymer obtained by further modifying and polymerizing components in mixture in which composition ratio is adjusted
A modified product obtained by further modifying the isolated single substance
A polymer obtained by further polymerizing the isolated single substance
Modified polymer obtained by further modifying and polymerizing the isolated single substance

It is noted that the above-described single substance also includes an oligomer such as a dimer and a trimer.

From the viewpoints that the effect of the present invention is more excellent and the biodegradability of the composition is excellent, the cardanol compound is preferably at least one selected from the group consisting of a compound represented by General Formula (CDN1) and a polymer of a compound represented by General Formula (CDN1).

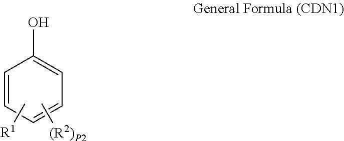

In General Formula (CND1), R¹ represents an alkyl group which may have a substituent or an unsaturated aliphatic group which may have a substituent. R²'s each independently represent a hydroxy group, a carboxy group, an alkyl group which may have a substituent, or an unsaturated aliphatic group which may have a substituent. P2 represents an integer of 0 to 4. In a case where a plurality of R²'s are present, the plurality of R²'s may be the same as or different from each other.

The number of carbon atoms in the alkyl group which may have a substituent, represented by R¹, is preferably 3 to 30, more preferably 5 to 25, and still more preferably 8 to 20.

Examples of the substituent which may be contained in the alkyl group include a hydroxy group, an ether bond-containing group (for example, an alkoxy group, an epoxy group, and an oxetanyl group), an acyl group, and an ester bond-containing group (for example, an alkyloxycarbonyl group and an alkylcarbonyloxy group).

Examples of the alkyl group which may have a substituent include a pentadecan-1-yl group, a heptan-1-yl group, an octan-1-yl group, a nonan-1-yl group, a decan-1-yl group, an undecan-1-yl group, a dodecan-1-yl group, a tetradecan-1-yl group, and the like.

The number of carbon atoms in the unsaturated aliphatic group which may have a substituent, represented by R¹, is preferably 3 to 30, more preferably 5 to 25, and still more preferably 8 to 20.

The unsaturated aliphatic group preferably has at least one double bond. The number of double bonds of the unsaturated aliphatic group is preferably 1 to 3.

Examples of the substituent which may be contained in the unsaturated aliphatic group include the substituent which may be contained in the above-described alkyl group.

Examples of the unsaturated aliphatic group which may have a substituent include a pentadec-8-en-1-yl group, a pentadec-8,11-dien-1-yl group, a pentadec-8,11,14-trien-1-yl group, a pentadec-7-en-1-yl group, a pentadec-7,10-dien-1-yl group, a pentadec-7,10,14-trien-1-yl group, and the like.

As R¹, a pentadec-8-en-1-yl group, a pentadec-8,11-dien-1-yl group, a pentadec-8,11,14-trien-1-yl group, a pentadec-7-en-1-yl group, a pentadec-7,10-dien-1-yl group, or a pentadec-7,10,14-trien-1-yl group is preferable.

In General Formula (CND1), the definition and preferred aspects of the alkyl group which may have a substituent and the unsaturated aliphatic group which may have a substituent, represented by R², are the same as those of the alkyl group which may have a substituent and the unsaturated aliphatic group which may have a substituent, represented by R¹.

The compound represented by General Formula (CDN1) and the polymer thereof may be modified, for example, may be epoxidized. Specifically, the compound may be a compound represented by General Formula (CDN1-e) in which the hydroxy group contained in the compound represented by General Formula (CDN1) is substituted with the following group (EP).

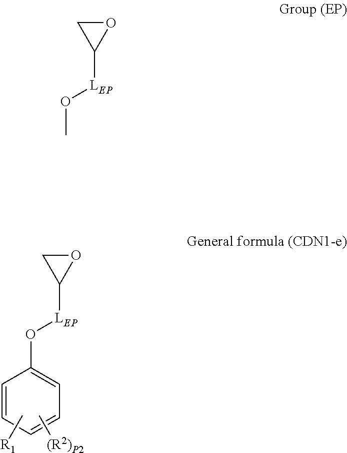

In the group (EP) and General Formula (CDN1-e), L_{EP} represents a single bond or a divalent linking group. In General Formula (CDN1-e), R¹, R², and P2 are the same as R¹, R², and P2 in General Formula (CND1).

Examples of the divalent linking group represented by L_{EP} include an alkylene group (preferably having 1 to 4 carbon atoms and more preferably having 1 carbon atom) which may have a substituent, a —CH₂CH₂OCH₂CH₂— group, and the like.

Examples of the substituent which may be contained in the alkylene group include a substituent which may be contained in the alkyl group represented by R¹ in General Formula (CDN).

As L_{EP}, a methylene group is preferable.

The polymer of the compound represented by General Formula (CDN1) refers to a polymer in which the compounds represented by General Formula (CDN1) are linked through a linking group or a single bond, and examples thereof include a compound represented by General Formula (CDN2).

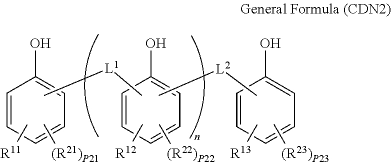

In General Formula (CDN2), R¹¹, R¹², and R¹³ each independently represent an alkyl group which may have a substituent or an unsaturated aliphatic group which may have a substituent. R²¹, R²², and R²³ each independently represent a hydroxy group, a carboxy group, an alkyl group which may have a substituent, or an unsaturated aliphatic group which may have a substituent. P21 and P23 each independently represent an integer of 0 to 3. P22 represents an integer of 0 to 2. L¹ and L² each independently represent a divalent linking group. n represents an integer of 0 or more and 10 or less.

In a case where a plurality of R²¹'s, R²²'s, R²³'s, R¹²'s, P22's, and L¹'s are present, the plurality of R²¹'s, R²²'s, R²³'s, R¹²'s, P22's, and L¹'s may be the same as or different from each other.

In General Formula (CDN2), the definitions and preferred aspects of R¹¹, R¹², and R¹³ are the same as those of the group represented by R¹ in General Formula (CDN1), and the definitions and preferred aspects of R²¹, R²², and R²³ are the same as those of the group represented by R² in General Formula (CDN1).

In General Formula (CDN2), examples of the divalent linking group represented by L¹ and L² include an alkylene group (preferably having 2 to 30 carbon atoms and more preferably having 5 to 20 carbon atoms) which may have a substituent. Examples of the substituent which may be contained in the alkylene group include a substituent which may be contained in the alkyl group represented by R¹ in General Formula (CDN).

In General Formula (CDN2), n is preferably 1 to 10 and more preferably 1 to 5.

The compound represented by General Formula (CDN2) may be modified, for example, may be epoxidized. Specifically, the compound may be a compound represented by General Formula (CDN2-e) in which the hydroxy group contained in the compound represented by General Formula (CDN2) is substituted with the above-described group (EP).

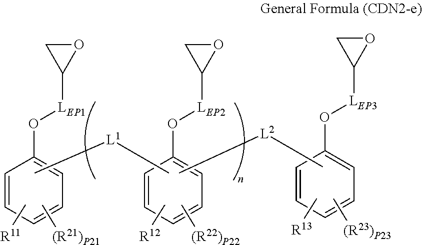

In General Formula (CDN2-e), R¹¹, R¹², R¹³, R²¹, R²², R²³, P21, P22, P23, L¹, L², and n have the same meanings as R¹¹, R¹², R¹³, R²¹, R²², R²³, P21, P22, P23, L¹, L², and n in General Formula (CDN2).

L_{EP1}, L_{EP2}, and L_{EP3} each independently represent a single bond or a divalent linking group. In a case where a plurality of L_{EP2}'s are present, the plurality of L_{EP2}'s may be the same as or different from each other.

In General Formula (CDN2), the definition and the preferred aspect of the group represented by L_{EP1}, L_{EP2}, and L_{EP3} are the same as those of L_{EP} in the group (EP).

The polymer of the compound represented by General Formula (CDN1) and the polymer of the compound represented by General Formula (CDN1-e) may be a three-dimensionally crosslinked polymer. Examples of these polymers include compounds represented by the following structural formulae.

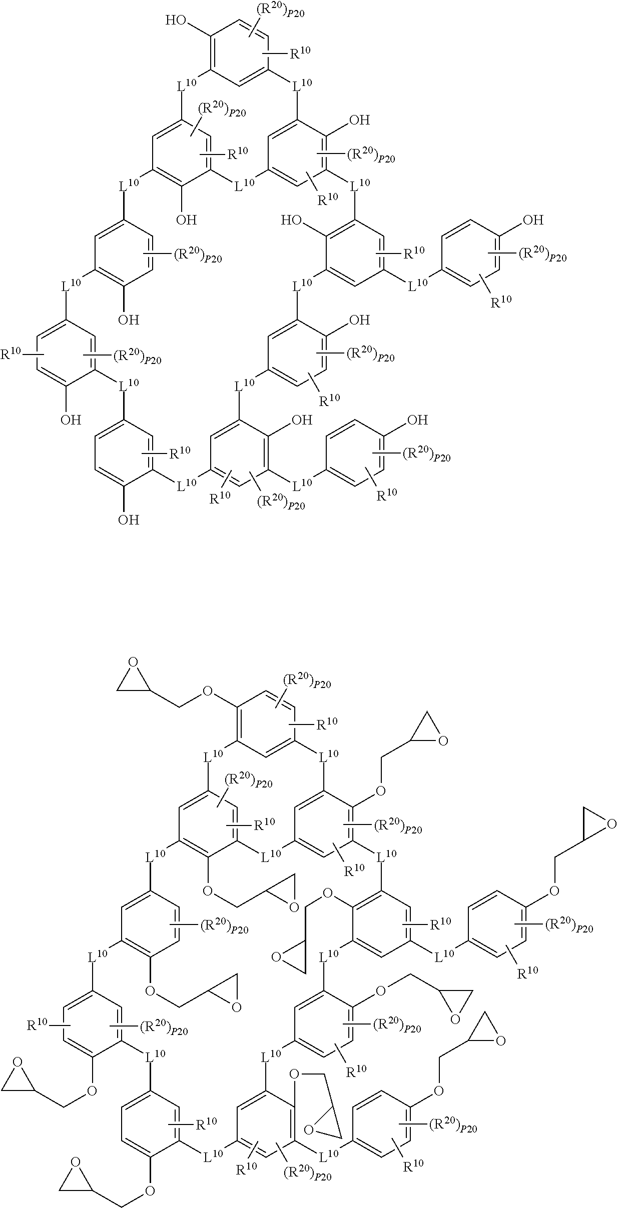

In the structural formulae, R¹⁰, R²⁰, and P20 have the same meanings as R¹, R², and P2 in General Formula (CDN1). L¹⁰ has the same meaning as L¹ in General Formula (CDN2). A plurality of R¹⁰'s, R²⁰'s, P20's, and L¹⁰'s may be the same as or different from each other.

As the cardanol compound, a commercially available product may be used. Examples of the commercially available product include NX-2024, Ultra LITE 2023, NX-2026, GX-2503, NC-510, LITE 2020, NX-9001, NX-9004, NX-9007, NX-9008, NX-9201, and NX-9203 manufactured by Cardolite Corporation, LB-7000, LB-7250, and CD-5L manufactured by Tohoku Chemical Industries, Ltd., and the like. Examples of a commercially available product of the cardanol compound having an epoxy group include NC-513, NC-514S, NC-547, LITE 513E, Ultra LITE 513, which are manufactured by Cardolite Corporation, and the like.

The hydroxyl number of the cardanol compound is preferably 100 mgKOH/g or more, more preferably 120 mgKOH/g or more, and still more preferably 150 mgKOH/g or more. The hydroxyl number of the cardanol compound is measured according to Method A of ISO 14900.

In a case where the cardanol compound is modified with an epoxy group, the epoxy equivalent is preferably 300 to 500, more preferably 350 to 480, and still more preferably 400 to 470. The epoxy equivalent is measured according to ISO 3001.

The molecular weight of the cardanol compound is preferably 250 to 1,000, more preferably 280 to 800, and still more preferably 300 to 500. In a case where the cardanol compound has a molecular weight distribution, the molecular weight represents a weight-average molecular weight.

### <Ester Compound>

The ester compound is a compound different from each of the above-described components (cellulose derivative, polyrotaxane, and cardanol compound).

Examples of the ester compound include a carboxylic acid ester compound, a phosphoric acid ester compound, and a condensed phosphoric acid ester compound, and a carboxylic acid ester compound is preferable.

Examples of the carboxylic acid ester compound include a fatty acid ester compound and an aromatic carboxylic acid ester compound.

Examples of the fatty acid ester compound include an aliphatic monocarboxylic acid ester (an acetic acid ester and the like), an aliphatic dicarboxylic acid ester (a succinic acid ester, an adipic acid ester-containing compound, an azelaic acid ester, a sebacic acid ester, a stearic acid ester, and the like), and an aliphatic tricarboxylic acid ester (a citric acid ester, an isocitric acid ester, and the like).

Examples of the aromatic carboxylic acid ester compound include dimethyl phthalate, diethyl phthalate, bis(2-ethylhexyl) phthalate, a terephthalic acid ester, and the like.

From the viewpoint that the effect of the present invention is more excellent, the carboxylic acid ester compound is preferably a fatty acid ester compound, more preferably an aliphatic dicarboxylic acid ester or an aliphatic tricarboxylic acid ester, and still more preferably a citric acid ester, an adipic acid ester, or a sebacic acid ester.

Examples of the carboxylic acid ester compound include an ester of a carboxylic acid forming each carboxylic acid ester compound and an alcohol.

The number of carbon atoms in the above-described alcohol is preferably 1 to 12 and more preferably 1 to 8.

Examples of the above-described alcohol include monohydric alcohols such as methanol, ethanol, propanol, butanol, and 2-ethylhexanol; and polyhydric alcohols such as glycerin, polyglycerin (diglycerin and the like), pentaerythritol, ethylene glycol, diethylene glycol, propylene glycol, trimethylolpropane, trimethylolethane, and sugar alcohols.

The carboxylic acid ester compound may be modified, and may be, for example, an epoxidized fatty acid ester.

The epoxidized fatty acid ester is an ester compound having a structure in which a carbon-carbon unsaturated bond of an unsaturated fatty acid ester is epoxidized (that is, oxacyclopropane). Examples of the epoxidized fatty acid ester include an ester of a fatty acid and an alcohol, in which a part or all of carbon-carbon unsaturated bonds in an unsaturated fatty acid (for example, oleic acid, palmitoleic acid, vaccenic acid, linoleic acid, linolenic acid, and nervonic acid) are epoxidized. Examples of the above-described alcohol include monohydric alcohols such as methanol, ethanol, propanol, butanol, and 2-ethylhexanol; and polyhydric alcohols such as glycerin, polyglycerin (diglycerin and the like), pentaerythritol, ethylene glycol, diethylene glycol, propylene glycol, trimethylolpropane, trimethylolethane, and sugar alcohols.

Examples of the epoxidized fatty acid ester include epoxidized soybean oil, epoxidized linseed oil, an epoxidized isobutyl rapeseed fatty acid ester, and an epoxidized 2-ethylhexyl fatty acid ester.

As the phosphoric acid ester compound, a phosphoric acid triester is preferable.

Examples of the phosphoric acid triester include tris(2-ethylhexyl) phosphate, triphenyl phosphate, tritolyl phosphate, isodecyl diphenyl phosphate, t-butylphenyl diphenyl phosphate, and isopropylphenyl diphenyl phosphate.

The molecular weight of the ester compound is preferably 200 to 2,000, more preferably 250 to 1,500, and still more preferably 280 to 1,000. It is noted that in a case where the ester compound has a molecular weight distribution, the molecular weight represents a weight-average molecular weight.

### <Alkyl Diol>

The alkyl diol is a compound in which an alkane is substituted with two hydroxy groups, and is a compound different from each of the above-described components (cellulose derivative, polyrotaxane, cardanol compound, and ester compound).

The above-described alkane may be linear, branched, or cyclic, and is preferably linear or branched, and more preferably linear.

From the viewpoint that the volatilization of the alkyl diol can be suppressed and the compatibility with the above-described cellulose derivative is excellent, the number of carbon atoms in the above-described alkane is preferably 8 to 20 and more preferably 9 to 14.

The substitution position of the hydroxy group is not particularly limited, but it is preferable that the hydroxy group is substituted at two termini of the alkane.

Examples of the above-described alkyl diol include 1,9-nonanediol, 1,10-decanediol, 1,2-decanediol, 1,6-decanediol, 1,11-undecanediol, 1,10-undecanediol, 1,12-dodecanediol, 1,2-dodecanediol, 1,13-tridecanediol, 1,14-tetradecanediol, 1,2-tetradecanediol, and the like.

Among these, from the viewpoint that the effect of the present invention is more excellent, the plasticizer is preferably at least one selected from the group consisting of a cardanol compound, a carboxylic acid ester compound, and an alkyl diol having 9 to 14 carbon atoms, and more preferably a cardanol compound.

The plasticizer may be used alone or in combination of two or more types thereof.

From the viewpoint that the effect of the present invention is more excellent, the mass ratio of the content of the plasticizer to the content of the cellulose derivative is preferably 0.01 to 0.35, more preferably 0.07 to 0.3, and still more preferably 0.1 to 0.2.

From the viewpoint that the effect of the present invention is more excellent, the content of the plasticizer is preferably 1% to 30% by mass, more preferably 5% to 25% by mass, and still more preferably 10% to 20% by mass with respect to the total mass of the composition.

### [Solvent]

It is also preferable that the composition does not substantially contain a solvent.

The fact that the composition does not substantially contain a solvent means that the content of the solvent is less than 0.3% by mass with respect to the total mass of the composition, and the content of the solvent is preferably 0.1% by mass or less and more preferably 0% by mass.

The solvent is intended to be a component which is a liquid at room temperature (25° C.) and has a boiling point of lower than 100° C. at 1 atm (760 mmHg), and examples thereof include known organic solvents.

Examples of the organic solvent include an ester solvent, a ketone solvent, an ether solvent, an alcohol solvent, a halogenated hydrocarbon solvent, and a hydrocarbon solvent.

The content of the solvent can be measured by, for example, pyrolysis mass spectrometry, or the like.

### [Other Components]

The composition may include other components other than those described above. Examples of the other components include a flame retardant, a compatibilizer, an oxidation inhibitor, a stabilizer, a mold release agent, a light stabilizer, a weather stabilizer, a colorant, a pigment, a modifier, a drip inhibitor, an antistatic agent, a hydrolysis inhibitor, a filler, a reinforcing material (glass fiber, carbon fiber, talc, clay, mica, glass flakes, milled glass, glass beads, crystalline silica, alumina, silicon nitride, aluminum nitride, boron nitride, and the like), an acid scavenger (metal oxides such as magnesium oxide and aluminum oxide, metal hydroxides such as magnesium hydroxide, calcium hydroxide, aluminum hydroxide, and hydrotalcite, calcium carbonate, talc, and the like), a reactive trap agent (an epoxy compound, an acid anhydride, a carbodiimide, and the like), and the like.

The composition may contain other resins different from the cellulose derivative, but the content of the other resins is preferably 5% by mass or less, more preferably less than 1% by mass, and still more preferably 0% by mass (that is, the other resin is not contained) with respect to the total mass of the composition.

Examples of the other resins include known thermoplastic resins, and specific examples thereof include a polycarbonate resin, a polypropylene resin, a polyester resin, a polyolefin resin, a polyester carbonate resin, a polyphenylene ether resin, a polyphenylene sulfide resin, a polysulfone resin, a polyether sulfone resin, a polyarylene resin, a polyether imide resin, a polyacetal resin, a polyvinyl acetal resin, a polyketone resin, a polyether ketone resin, a polyether ether ketone resin, a polyarylene ketone resin, a polyether nitrile resin, a liquid crystal resin, a polybenzimidazole resin, a polyparabanic acid resin, a diene-aromatic alkenyl compound copolymer, a vinyl cyanide-diene-aromatic alkenyl compound copolymer, an aromatic alkenyl compound-diene-vinyl cyanide-N-phenylmaleimide copolymer, a vinyl cyanide-(ethylene-diene-propylene (EPDM))-aromatic alkenyl compound copolymer, a polyvinyl chloride resin, a chlorinated polyvinyl chloride resin, and a vinyl-based polymer or copolymer obtained by polymerizing or copolymerizing one or more vinyl monomers selected from the group consisting of an aromatic alkenyl compound, a methacrylic acid ester, an acrylic acid ester, and a vinyl cyanide compound.

### [Characteristics of Composition]

Hereinafter, the characteristics of the composition will be described in detail.

### <Amorphous>

The composition according to the embodiment of the present invention is amorphous.

In the present specification, the expression “the composition is amorphous” is intended to mean that the composition does not have a melting point, and specifically, it means that a melting peak of a crystal is not observed in a case where a differential scanning calorimetry (DSC) is performed on the composition by the following method.

Using a differential scanning calorimeter (manufactured by PerkinElmer, Inc., DSC4000), the temperature is raised from 30° C. to 350° C. at a temperature rising rate of 2° C./min, the temperature is lowered from 350° C. to 30° C. at a temperature lowering rate of 10° C./min, the temperature is raised again from 30° C. to 350° C. at a temperature rising rate of 2° C./min, and a DSC profile of 10 mg of the composition is obtained. The presence or absence of an endothermic peak in the first temperature rising process is confirmed for the obtained DSC profile. In a case where the peak is not present, the composition is amorphous, and in a case where the peak is present, the composition contains crystals (that is, the composition is crystalline). However, in the DSC profile, a peak of which a peak top is within ±0.8 mW with respect to a straight line connecting a start to an end of each temperature rising process or temperature lowering process (for example, in the first temperature rising process, a straight line connecting 30° C. to 350° C. in the first temperature rising process) is noise and is not included in the peak.

### <Maximum Impact Force>

The maximum impact force of the composition is preferably 3,600 N or more, more preferably 3,700 N or more, still more preferably 3,800 N or more, and particularly preferably 4,000 N or more. The upper limit is not particularly limited, and is 10,000 N or less in many cases.

The maximum impact force of the composition can be measured using the method described in ISO 6603-2:2000.

The maximum impact force of the composition can be adjusted, for example, by adjusting the composition of the composition.

### <Energy at Maximum Impact Force>

The energy of the composition at the maximum impact force is preferably 10 J or more, more preferably 15 J or more, and still more preferably 20 J or more. The upper limit is not particularly limited, and is 100 J or less in many cases.

The energy at the maximum impact force of the composition can be measured using the method described in ISO 6603-2:2000.

The energy at the maximum impact force of the composition can be adjusted, for example, by adjusting the composition of the composition.

### [Molded Body]

The molded body according to the embodiment of the present invention is a molded body consisting of the composition according to the embodiment of the present invention, that is, an amorphous molded body containing a cellulose derivative and a polyrotaxane.

The molded body is preferably an injection molded body obtained by injection molding of the composition, a blow molded body obtained by blow molding, or a film-shaped molded body.

Examples of the method for molding the molded body include a method of melting the composition and molding the molded body, and specific examples thereof include injection molding, extrusion molding, blow molding, hot press molding, calender molding, vacuum molding, transfer molding, and the like. Among these, from the viewpoint of a high degree of freedom in shape, injection molding or blow molding is preferable and injection molding is more preferable.

The cylinder temperature during the injection molding can be appropriately adjusted according to the composition, and is preferably 160° C. to 280° C. and more preferably 200° C. to 270° C.

The mold temperature during the injection molding can be appropriately adjusted according to the composition, and is preferably 40° C. to 90° C. and more preferably 40° C. to 60° C.

The injection molding may be performed using, for example, commercially available devices such as NEX500 manufactured by Nissei Plastic Industrial Co., Ltd., NEX150 manufactured by Nissei Plastic Industrial Co., Ltd., NEX7000 manufactured by Nissei Plastic Industrial Co., Ltd., PNX40 manufactured by Nissei Plastic Industrial Co., Ltd., and SE50D manufactured by Sumitomo Heavy Industries, Ltd.

It is also preferable that the molded body does not substantially contain a solvent.

The fact that the molded body does not substantially contain a solvent means that the content of the solvent is less than 0.3% by mass with respect to the total mass of the molded body, and the content of the solvent is preferably 0.1% by mass or less and more preferably 0% by mass.

The definition and examples of the solvent are as described above.

The content of the solvent can be measured by, for example, pyrolysis mass spectrometry, or the like.

The molded body can be suitably used for applications such as electronic and electrical equipment, office equipment, home appliances, automotive interior materials, toys, and containers. Specific examples of the applications of the molded body according to the present embodiment include a housing of an electronic or electric device or a home appliance; various components of an electronic or electric device or a home appliance; interior and exterior components of an automobile; a building block toy; a plastic model kit; a storage case for a CD-ROM or a DVD; tableware; a beverage bottle; a food tray; a wrapping material; a film; a sheet; an eyeglass frame; a housing of a drone; and the like.

### [Method for Producing Composition]

The method for producing the composition is not particularly limited as long as it is a method in which an amorphous composition is obtained. Among these, from the viewpoint that the formation of an amorphous composition is easy, a method of mixing a cellulose derivative, a polyrotaxane, and any optional component other than the above, as necessary, and melt-kneading the mixture in a substantially solvent-free manner is preferable.

As the method of the above-described melt-kneading, a known method can be used, and examples thereof include a twin-screw extruder, a Henschel mixer, a Banbury mixer, a single-screw extruder, a multi-screw extruder, a Ko-Kneader, and the like.

It is noted that in the method for producing a composition, the term “in a substantially solvent-free manner” means that during kneading, the content of the solvent is less than 0.3% by mass, preferably 0.1% by mass or less, and more preferably 0% by mass with respect to the total mass of the mixture.

The solvent is intended to be a component which is a liquid at room temperature (25° C.) and has a boiling point of lower than 100° C. at 1 atm (760 mmHg), and examples thereof include known organic solvents.

Examples of the organic solvent include an ester solvent, a ketone solvent, an ether solvent, an alcohol solvent, a halogenated hydrocarbon solvent, and a hydrocarbon solvent.

### EXAMPLES

Hereinafter, the present invention will be described in more detail with reference to Examples.

The materials, the amounts and proportions of the materials used, the details of treatments, the procedure of treatments, and the like shown in the following Examples can be appropriately modified as long as the gist of the present invention is maintained. Therefore, the scope of the present invention should not be construed as being limited to Examples shown below.

### [Preparation of Materials]

The following materials were prepared.

### <Cellulose Derivative>

CA01: L50, manufactured by Daicel Corporation, cellulose acetate, acetyl substitution degree of 2.4, Mw: 157,000
CA02: CA398-3, manufactured by Eastman Chemical Company, cellulose acetate, acetyl substitution degree of 2.2, Mw: 37,000
CA03: CAP482-20, manufactured by Eastman Chemical Company, cellulose acetate propionate, acetyl substitution degree of 0.18, propionyl substitution degree of 2.4, Mw: 205,000
CA04: CAB381-20, manufactured by Daicel Corporation or Eastman Chemical Company, cellulose acetate butyrate, acetyl substitution degree of 0.4, butyl substitution degree of 2.3, Mw: 223,000
CA06: Cellulose acetate, acetyl substitution degree of 1.75, Mw: 122,000
CA07: Cellulose acetate, acetyl substitution degree of 1.65, Mw: 118,000
CA08: Cellulose acetate, acetyl substitution degree of 2.75, Mw: 165,000
CA09: Cellulose acetate, acetyl substitution degree of 2.85, Mw: 172,000
CA10: Cellulose acylate synthesized according to the method described in paragraph [0092] of JP2009-204834A

The acyl substitution degree of the above-described cellulose derivative was determined by preparing a measurement sample using tetrahydrofuran-d8 as the solvent and tetramethylsilane as the reference substance, with a sample concentration of 1% by mass and a 5 mmφ sample tube, performing ¹H-NMR (JMN-ECA, manufactured by JEOL Resonance Inc., frequency of 500 MHz, number of times of integration of 32, measurement temperature of 30° C.) measurement, and calculating according to the above-described method.

### <Polyrotaxane>

PR1: Polyrotaxane synthesized by the following method according to the method described in RSC Adv. 2022, 12, 3796-3800 (polyrotaxane in which cyclodextrin is unmodified)

A mixed solution obtained by dissolving 240 g of (2-hydroxypropyl)-α-cyclodextrin (weight-average molecular weight of 1,180) and 120 g of terminal amine polyethylene glycol (number-average molecular weight of 10,000) in 1,000 mL of 0.1 mol/L phosphate buffer solution was refrigerated for 65 hours. Thereafter, the mixed solution was returned to room temperature, 30 g of 3-hydroxyadamantane-1-carboxylic acid and 70 g of 4-(4,6-dimethoxy-1,3,5-triazin-2-yl)-4-methylmorpholinium chloride were added thereto, the mixture was stirred at room temperature for 24 hours, 70 g of 4-(4,6-dimethoxy-1,3,5-triazin-2-yl)-4-methylmorpholinium chloride was added thereto, and the mixture was further stirred for 24 hours. Thereafter, the reactant was purified by ultrafiltration and freeze-dried to obtain 300 g of PR1.
PR2: Selm Super Polymer SH2400P, manufactured by ASM Inc. (modified polyrotaxane in which cyclodextrin is modified with a caprolactone chain)
PR3: Polyrotaxane synthesized according to the method described in paragraph [0083] of JP2009-204834A

### <Plasticizer>

PC1: NX2026, manufactured by Cardolite Corporation, cardanol compound
PC2: UL501, manufactured by Cardolite Corporation, cardanol compound
PC3: Triethyl citrate, manufactured by FUJIFILM Wako Pure Chemical Corporation, Shonan, carboxylic acid ester compound
PC4: C-1090, manufactured by Kuraray Co., Ltd., nonanediol
PC5: ADK CIZER O-139P, manufactured by Adeka Corporation, epoxidized soybean oil
PC6: TPP, manufactured by DAIHACHI CHEMICAL INDUSTRY CO., LTD., triphenyl phosphate
PC7: Dibutyl phosphate

### [Production of Composition]

### Examples 1 to 21 and Comparative Examples 1 and 2

Raw materials shown in Table 1 below were put into a twin-screw extruder (manufactured by SHIBAURA MACHINE CO., LTD., TEM48SS) to have the composition shown in Table 1, and kneaded at a cylinder temperature shown in Table 1, extruded into strands, cooled in a cooling tank, and cut with a rotary cutter to obtain composition pellets.

### Comparative Example 3

A film was obtained by a solution casting method according to the method described in [Example-1] of [0098] to [0100] of JP2009-204834A.

### <Confirmation of Amorphous State>

For the pellets or films of each of Examples and Comparative Examples prepared by the above-described method, the amorphous state was confirmed by the above-described method using a differential scanning calorimeter (manufactured by PerkinElmer Inc., DSC4000).

### [Evaluation]

In Examples 1 to 21 and Comparative Examples 1 and 2, using the obtained composition pellets, a D2 test piece (width×length×thickness=60×60×2 mm) was molded at a cylinder temperature shown in Table 1 and a mold temperature of 40° C. using an injection molding device (manufactured by Nissei Plastic Industrial Co., Ltd., NEX80).

In Comparative Example 3, 30 sheets of the film obtained by the above-described method were laminated, heat-pressed at 150° C. for 1 hour, and cut into a size of width×length×thickness=60×60×2 mm to prepare a D2 test piece.

For each of the obtained D2 test pieces, a maximum impact force (N) and energy (J) at the maximum impact force were measured by a puncture test apparatus (manufactured by Shimadzu Corporation, Hydroshot HITS-PX) by a method according to ISO 6603-2:2000.

### [Result]

Table 1 shows the composition, the kneading condition, and the evaluation results of each composition.

In Table 1, the column of “(B)/(A)” indicates the mass ratio of the content of the polyrotaxane (B) to the content of the cellulose derivative (A).

In Table 1, in <Confirmation of amorphous state> described above, the composition confirmed to be amorphous is described as “Amorphous”, and the composition in which the melting peak of the crystal is confirmed is described as “Crystalline”.

TABLE 1

| | Composition | | | | | | | | Kneading | | Evaluation results | |
|---|---|---|---|---|---|---|---|---|---|---|---|---|
| | Cellulose derivative (A) | | | Polyrotaxane (B) | | Plasticizer (C) | | | condition | | Maximum | Energy at |
| | | Acyl | Part | | Part | | Part | | Cylinder | | impact | maximum |
| | Com- | substitution | by | Com- | by | Com- | by | | temperature | | force | impact |
| | pound | degree | mass | pound | mass | pound | mass | (B)/(A) | (° C.) | Amorphous | (N) | force (J) |
| Example 1 | CA01 | 2.4 | 100 | PR1 | 1 | | | 0.01 | 260 | Amorphous | 5800 | 40 |
| Example 2 | CA02 | 2.2 | 100 | PR1 | 1 | | | 0.01 | 260 | Amorphous | 4900 | 31 |
| Example 3 | CA03 | 2.58 | 100 | PR1 | 1 | | | 0.01 | 260 | Amorphous | 5100 | 32 |
| Example 4 | CA04 | 2.7 | 100 | PR1 | 1 | | | 0.01 | 240 | Amorphous | 4400 | 24 |
| Example 5 | CA06 | 1.75 | 100 | PR1 | 1 | | | 0.01 | 240 | Amorphous | 5100 | 31 |
| Example 6 | CA07 | 1.65 | 100 | PR1 | 1 | | | 0.01 | 260 | Amorphous | 4300 | 21 |
| Example 7 | CA08 | 2.75 | 100 | PR1 | 1 | | | 0.01 | 260 | Amorphous | 4400 | 25 |
| Example 8 | CA09 | 2.85 | 100 | PR1 | 1 | | | 0.01 | 260 | Amorphous | 4300 | 21 |
| Example 9 | CA01 | 2.4 | 100 | PR2 | 1 | | | 0.01 | 260 | Amorphous | 5100 | 32 |
| Example 10 | CA01 | 2.4 | 100 | PR1 | 0.2 | | | 0.002 | 260 | Amorphous | 5000 | 33 |
| Example 11 | CA01 | 2.4 | 100 | PR1 | 10 | | | 0.10 | 260 | Amorphous | 4900 | 31 |
| Example 12 | CA01 | 2.4 | 100 | PR1 | 12 | | | 0.12 | 260 | Amorphous | 4000 | 18 |
| Example 13 | CA01 | 2.4 | 100 | PR1 | 1 | PC1 | 10 | 0.01 | 220 | Amorphous | 6500 | 55 |
| Example 14 | CA01 | 2.4 | 100 | PR1 | 1 | PC2 | 10 | 0.01 | 220 | Amorphous | 6300 | 52 |
| Example 15 | CA01 | 2.4 | 100 | PR1 | 1 | PC3 | 10 | 0.01 | 220 | Amorphous | 5500 | 46 |
| Example 16 | CA01 | 2.4 | 100 | PR1 | 1 | PC4 | 10 | 0.01 | 230 | Amorphous | 5400 | 46 |
| Example 17 | CA01 | 2.4 | 100 | PR1 | 1 | PC5 | 10 | 0.01 | 240 | Amorphous | 4200 | 20 |
| Example 18 | CA01 | 2.4 | 100 | PR1 | 1 | PC6 | 10 | 0.01 | 240 | Amorphous | 4300 | 21 |
| Example 19 | CA01 | 2.4 | 100 | PR1 | 1 | PC1 | 5 | 0.01 | 220 | Amorphous | 6200 | 50 |
| Example 20 | CA01 | 2.4 | 100 | PR1 | 1 | PC1 | 20 | 0.01 | 200 | Amorphous | 7000 | 67 |
| Example 21 | CA08 | 2.75 | 100 | PR1 | 12 | | | 0.12 | 260 | Amorphous | 4000 | 20 |
| Comparative | CA01 | 2.4 | 100 | | | | | | 270 | Amorphous | 350 | 2 |
| Example 1 | | | | | | | | | | | | |
| Comparative | CA01 | 2.4 | 100 | | | PC1 | 10 | | 240 | Amorphous | 500 | 4 |
| Example 2 | | | | | | | | | | | | |
| Comparative | CA10 | 0.89 | 15 | PR3 | 3 | PC6 | 0.9 | 0.20 | — | Crystalline | 300 | 1 |
| Example 3 | | | | | | PC7 | 0.9 | | | | | |

From the results shown in Table 1, it was confirmed that the composition according to the embodiment of the present invention has an excellent maximum impact force and an excellent energy at the maximum impact force, that is, an excellent surface impact strength.

From the comparison of Examples 1 to 8, it was confirmed that the surface impact strength was more excellent in a case where the acyl substitution degree was 1.7 to 2.6.

From the comparison between Example 1 and Example 10, it was confirmed that the surface impact strength was more excellent in a case where the cyclic molecule of the polyrotaxane did not have a side chain.

From the comparison between Examples 1 and 10 to 12 and the comparison between Examples 7 and 21, it was confirmed that the surface impact strength was more excellent in a case where the mass ratio of the content of the polyrotaxane to the content of the cellulose derivative was 0.10 or less.

From the comparison of Examples 13 to 18, it was confirmed that the surface impact strength was more excellent in a case where the plasticizer is at least one selected from the group consisting of a cardanol compound, a carboxylic acid ester compound, and an alkyl diol having 9 to 14 carbon atoms, and the surface impact strength was still more excellent in a case where the plasticizer is a cardanol compound.

From the comparison of Examples 13 and 19 to 20, it was confirmed that the surface impact strength was more excellent in a case where the content of the plasticizer was 10% to 20% by mass with respect to the total mass of the composition.

### [Evaluation of Biodegradability]

The biodegradability was evaluated by the following procedure using the composition pellets of Examples 1 and 15.

100 g of the composition pellet was pulverized using a lab mill (manufactured by DALTON CORPORATION, Lab Mill LM-05) while liquid nitrogen was being added thereto, and the pulverized product was sieved through a sieve having a mesh size of 100 m, and 30 g of the powder that had passed through the sieve was collected. Using the obtained composition powder, a weight loss rate (compost degradation rate) after 28 days was measured by a method according to ISO-14855, and the biodegradability was evaluated. As a result, the weight loss rate of Example 1 was 56%, and the weight loss rate of Example 15 was 82%, both of which exhibited biodegradability. That is, it has been confirmed that the composition according to the embodiment of the present invention has excellent surface impact strength and exhibits biodegradability.

What is claimed is:

1. A composition comprising:
a cellulose derivative; and
a polyrotaxane,
wherein the composition is amorphous.

2. The composition according to claim 1,
wherein the cellulose derivative is a cellulose acylate.

3. The composition according to claim 2,
wherein an acyl substitution degree of the cellulose acylate is 1.7 to 2.6.

4. The composition according to claim 1,
wherein the cellulose derivative is at least one selected from the group consisting of a cellulose acetate, a cellulose acetate propionate, and a cellulose acetate butyrate.

5. The composition according to claim 1,
wherein the cellulose derivative is a cellulose acetate.

6. The composition according to claim 5,
wherein an acetyl substitution degree of the cellulose acetate is 1.7 to 2.6.

7. The composition according to claim 1, further comprising:
a plasticizer.

8. The composition according to claim 7,
wherein the plasticizer is at least one selected from the group consisting of a cardanol compound, a carboxylic acid ester compound, and an alkyl diol having 9 to 14 carbon atoms.

9. The composition according to claim 1,
wherein a mass ratio of a content of the polyrotaxane to a content of the cellulose derivative is 0.10 or less.

10. A molded body consisting of the composition according to claim 1.

11. The molded body according to claim 10,
wherein a maximum impact force is 4,000 N or more.

12. A method for producing a composition which contains a cellulose derivative and a polyrotaxane and is amorphous, the method comprising:
a step of melt-kneading the cellulose derivative and the polyrotaxane in a substantially solvent-free manner.

13. The composition according to claim 2,
wherein the cellulose derivative is at least one selected from the group consisting of a cellulose acetate, a cellulose acetate propionate, and a cellulose acetate butyrate.

14. The composition according to claim 2,
wherein the cellulose derivative is a cellulose acetate.

15. The composition according to claim 14,
wherein an acetyl substitution degree of the cellulose acetate is 1.7 to 2.6.

16. The composition according to claim 2, further comprising:
a plasticizer.

17. The composition according to claim 16,
wherein the plasticizer is at least one selected from the group consisting of a cardanol compound, a carboxylic acid ester compound, and an alkyl diol having 9 to 14 carbon atoms.

18. The composition according to claim 2,
wherein a mass ratio of a content of the polyrotaxane to a content of the cellulose derivative is 0.10 or less.

19. A molded body consisting of the composition according to claim 2.

20. The molded body according to claim 19,
wherein a maximum impact force is 4,000 N or more.
